(19) United States
(12) Patent Application Publication
(10) Pub. No.: US 2014/0108111 A1
(43) Pub. Date: Apr. 17, 2014

(54) MOBILE ADVERTISING SYSTEM

(71) Applicant: REDPIXTEC. GMBH, Wiesbaden (DE)

(72) Inventors: Sylvia Klein, Wiesbaden (DE); Torben Toepper, Bad Homburg (DE)

(73) Assignee: REDPIXTEC. GMBH, Wiesbaden (DE)

(21) Appl. No.: 13/650,317

(22) Filed: Oct. 12, 2012

(51) Int. Cl. G06Q 30/02

(52) U.S. Cl. CPC G06Q 30/0251
USPC 705/14.16; 705/14.49

(57) ABSTRACT

A mobile advertising system, a respective method and to a computer program product, wherein the mobile advertising system includes one or more mobile devices configured to capture a merchant's encoded vending detail, and being configured to communicate with a remote payment host. Upon completion of a payment procedure, the mobile device is operable to generate a recommendation on the basis of the captured vending details and to transfer the recommendation to at least one potential customer via a network.

### FIELD OF THE INVENTION

The present invention relates to a mobile advertising system providing advertising to potential customers via a network. Furthermore, the invention relates to a method of advertising as well as to a computer program product to run on a mobile device for advertising products, services or merchants to at least one potential customer.

### BACKGROUND OF THE INVENTION

There exists a variety of mobile payment systems allowing a user to execute monetary transactions. Most of such payment systems require that a vendor or a merchant of a particular product or service provides a respective payment infrastructure. Therefore, various brands and, for instance, online shops come along with unique and competitive mobile payment solutions, each requiring a rather elaborate and time-consuming adaptation of hardware and software.

Merchants already operating some kind of online shop may provide a recommendation functionality by way of which a customer may easily recommend a particular product or service to other potential customers. Recommendation-based advertisement among customers generally requires that relevant information about the product, the service or about the respective shop is automatically created and provided to the recommending customer. However, in situations where products or services are offered to customers in offline environment, forwarding of a respective recommendation requires that the user manually creates and manually submits a recommendation to a potential customer, (i.e. a friend). Manual creation of recommendations might be error-prone since the customer may not correctly specify or identify respective product-, service- or shop-information. Moreover, such a manual recommendation does not generate any benefit for the recommending user.

It is therefore an object of the present invention to provide and to support recommendation-based marketing, which is also usable by offline-operating merchants or service providers. Moreover, the invention also aims to encourage customers to distribute and to share payment- and/or purchase-related recommendations to potential customers, preferably to a group of potential customers.

### BRIEF SUMMARY OF THE INVENTION

In a first aspect, a mobile advertising system is provided comprising at least one mobile device. The mobile device is configured to scan or to capture encoded vending details of a merchant. The encoded vending details are typically provided by the merchant himself. Typically the vending details can be either displayed statically, in form of a printed label or dynamically, on a screen or display of the merchant.

The mobile device is further configured to communicate with a remote payment host in order to execute a payment transaction. Preferably, but not necessarily, the encoded vending details captured by the mobile device are required to execute the payment transaction. Upon completion of the payment procedure, the mobile device is further operable to generate a recommendation on the basis of the captured, encoded and/or decoded vending details. The mobile device is then further operable to transfer the recommendation to at least one potential customer via a network. Only non-transitory computer-readable media are within the scope of this application. Non-transitory computer-readable media comprise all computer-readable media except for a transitory, propagating signal.

Preferably, for generating and/or transferring of the recommendation it is required that the payment procedure has been completed in advance. Hence, the mobile device is operable to process a payment confirmation provided by the payment host after completion of a monetary transaction. By imposing the completion of a payment process as a prerequisite for generating and transferring a recommendation to other potential customers, the attention of potential customers receiving the recommendation could be increased, since the potential customer is aware of the fact that the user of the mobile device actually purchased the recommended product or service.

Moreover, by separately providing and capturing of the merchant's encoded vending details the payment process and the process of recommending can be effectively separated. The process of recommendation may then be exclusively conducted by the mobile device while the payment procedure may be exclusively conducted by the mobile device in communication with the payment host or otherwise. This way, the mobile advertising system can be universally adapted to a variety of different payment hosts and payment systems while providing a common recommendation platform and a respective recommendation procedure.

By means of the visual capturing (e.g. by scanning the merchant's encoded vending details), respective data and information about a product, a service and/or about a particular shop or service provider can be almost automatically obtained and further processed by the mobile device in order to generate a transferable recommendation.

Scanning of the merchant's encoded vending details may not only be used for recommendation- and advertising purpose but also for the payment process. For instance, the mobile device itself or the connected payment host may decode the vending details and may further display decoded vending details to the user prior to execute the payment procedure. Hence, the encoded vending details may be indicative of a particular item or service, a unique shop identifier of the merchant and may be further indicative of a price of the related product or service.

Irrespective whether the encoded vending details are used for a payment procedure, the captured vending details are to be used to generate a recommendation, typically reflecting facts and details of the product or service purchased by the user. The details may be further indicative of the merchant and his shop in general. The recommendation to be shared among the user and potential customers can be generated all-automatically so that it is no longer required that the user manually enters respective product-, service- or shop-information.

Preferably, the mobile device comprises a smart phone, a tablet computer or a comparable portable electronic device having at least a camera to capture the graphically displayed and encoded vending details.

In a further embodiment, the mobile advertising system further comprises an advertisement service to communicate with the mobile device and comprising a database to provide additional information in response to receive the captured vending details from the mobile device. The additional information typically relates to a product, to a service, or to a merchant's shop in general. The additional information is assigned to the predefined and capturable encoded vending details and will be provided to the mobile device upon request. Typically, once the payment transaction has been completed, the additional information can be automatically provided to the mobile device in response of transmitting the captured vending details to the advertisement service. Alternatively, the additional information may be provided to the mobile device only upon a user's request.

Decoding of the encoded vending details may either be conducted by the mobile device or by the advertisement service. The additional information is preferably presented to the user via the mobile device in a readable and decoded format so that the user can be informed about the additional shop-, product- or service-related information prior to a creation and/or distribution of the recommendation to other potential customers.

In a further embodiment, the advertisement service is also operable to generate the recommendation and to submit the recommendation to the mobile device. Alternatively, it is the mobile device alone, which may generate the recommendation on the basis of the captured encoded vending details and/or on the basis of the additional information provided by and obtained from the advertisement service.

By making use of a separate advertisement service with a respective database, the recommendation-based advertisement can be decoupled from an actual payment process. This way, the advertisement service may be configured to operate with a large variety of different payment providers.

In a further embodiment, the advertising service is further operable to track the recommendation and to record if the at least one potential customer receiving the recommendation follows the recommendation. Tracking of recommendations is typically based on web-tracking technologies. The recommendation, typically provided as or supplied with a hyperlink may be indicative of the user, who generated the recommendation. When the potential customer clicks on such a hyperlink, such clicking can be tracked and monitored either by cookie-technology or by respective clicking counters. The recommendation itself comprises an electronic message, in the form of an e-mail or an intra-community message posted on a web-page, an internet blog, in a social network or on similar internet-based communication platforms.

It is of particular benefit, when the payment system is further operable to determine and to provide a commission or a revenue to the advertisement service and/or to the user of the mobile device when the potential customer actually follows the recommendation. This way, the user purchasing a service or a product from the merchant may be further encouraged to submit a large number of respective recommendations to potential customers. The more potential customers actually following the recommending user, the larger the commission for the first user and/or for the advertisement service will be.

Since generation and transferring of a recommendation is only enabled by the mobile advertising system upon completion of a payment procedure, a user willing to recommend a particular product, service, or shop may be further encouraged to actually purchase a product or service and to conduct the respective payment. The possibility to receive a respective commission when submitting a recommendation to a rather large group of potential customers may then at least partially reimburse the recommending user for purchasing the respective product or service.

Typically and preferably, the mobile advertising system, especially the at least one mobile device, is operable to submit the recommendation to a social network to which the recommending user belongs to. By exploiting a message distribution function among linked users of a social network the respective recommendation can be submitted and advertised to a rather large group of potential customers in a very rapid way.

Hence, the advertisement service and/or the mobile device is or are operable to submit the prepared recommendation to a social network of the user of the mobile device. This way, the purchase-related recommendation can be easily and effectively shared among a group of users and potential customers in a very user-friendly, effective, and elegant way.

According to a further embodiment, the additional information stored in the database of the advertisement service is modifiable by the merchant. For instance, the merchant may be a subscriber of the advertisement service. The advertisement service, operated by an advertisement provider, may generate the encoded vending details to be displayed by the merchant.

In one embodiment, the encoded vending details are just indicative of a unique identifier of the merchant. Then, the merchant himself may modify the additional information, which is provided to the user upon completion of a respective payment procedure. For instance, the additional information may be indicative of the address and location of the merchant's shop. The information may be further indicative of opening and trading hours, special offers and other arbitrary shop- or service-related information, which may change from time to time.

Additionally, the merchant may be provided with a variety of different vending codes in order to identify and/or to label different products or services. Also here, the merchant may individually modify the information stored in the database and being assigned to the encoded vending details. For instance, the merchant may individually set price information, like a special offer, regarding to a particular product or service offered in the respective shop. The user scanning the encoded vending details will then receive a transferable recommendation being indicative of such modified additional information individually set by the merchant in advance. This way, the mobile advertising system allows easy distribution of a merchant's special offers among a social network of users who purchase a particular product or service.

In a further embodiment the recommendation is also modifiable by the mobile device and/or by the user of the respective mobile device. Typically, the mobile device provides an editor allowing the user thereof to enter a manually created comment or to enter further details to be shared and to be transferred to potential customers.

In another aspect also a method of advertising by means of at least one mobile device is provided. Said method comprises the steps of capturing a merchant's encoded vending details by means of the mobile device, processing of a payment with a remote payment host, generating a recommendation upon completion of the payment procedure on the basis of the captured vending details, and transferring the recommendation to at least one potential customer via a network.

By generating a recommendation after completion of a payment process and by generating said recommendation on the basis of encoded vending details actually captured by the mobile device of a user, vending details can be automatically obtained and processed even for offline trading, where a user physically interacts with the merchant. Generation and transferring of vending recommendations can be effectively decoupled from the payment process and may therefore be universally applicable to a large variety of different payment procedures and payment systems.

According to a further embodiment, the method also comprises the step of tracking the recommendation and determining and providing a commission or revenue to the user of the mobile device, when the potential customer actually follows the recommendation. The commission or revenue may depend on the activity of the potential customer. The revenue or commission will increase if the potential customer actually purchases a respective product from a recommended merchant. Typically, only a rather low or moderate commission will be provided if the potential customer only visits a merchant's homepage by clicking on a respective hyperlink included in the recommendation.

It is of further benefit when the user willing to recommend the merchant's products or services to a further customer is instantly informed about the commission or revenue to be obtained from a successful recommendation, thereby increasing the user's tendency to distribute respective recommendations to a large group of potential customers.

In still another aspect, there is also provided a computer program product to run at least on a mobile device of a user. The computer program product comprises computer program means to capture a merchant's encoded vending details and computer program means to process a payment with a remote payment host. The computer program product further comprises computer program means to generate a recommendation on the basis of the captured and eventually decoded vending details upon completion of the payment process. Furthermore, the computer program means are operable to transfer of the recommendation to at least one potential customer via a network.

Preferably, the computer program product is designed as a mobile application to communicate with an advertisement service. Upon capturing encoded vending details, either the computer program product itself or the advertisement service is operable to decode the captured vending details. The computer program product is further operable to submit the captured vending details to the advertisement service and to receive additional information either from a database of the advertisement service or from various other information sources, such as a search engine used or operated by the advertisement service.

In response to receiving the additional information from the advertisement service, the computer program product is operable to generate a transferable and electronic message-based recommendation and to provide a sharing or distributing functionality to the user of the mobile device. Preferably, the recommendation is not only indicative of the additional information retrieved from the advertisement service, but also includes at least an identifier of the recommending user, which is typically subscribed to the advertisement service.

This way, electronic recommendations to be transferred among users of a social network may uniquely correspond to a recommendation-generating user for assigning a respective commission to the user when the recommendation-receiving potential customer follows the respective recommendation (e.g. by purchasing a product or service from the recommended merchant).

Finally, it is to be mentioned that all features, benefits and general properties as described in connection with the mobile advertising system also refer to the mentioned computer program product and to the method of processing a payment. Mentioning of particular features, benefits and structural details described in connection with the mobile advertising system also refer in the same and analogous way to the method for processing a payment as well as to the computer program product to run at least on the mobile device; and vice versa.

### BRIEF DESCRIPTION OF THE DRAWINGS

FIG. 1 schematically illustrates a mobile advertising system;

FIG. 2 schematically shows the interaction of the mobile device with the advertisement service;

FIG. 3 schematically shows a sequence of interactions between the user and his mobile device for generating a recommendation; and

FIG. 4 shows a flowchart schematically illustrating various method steps during generation and distribution of an advertising recommendation.

### DETAILED DESCRIPTION

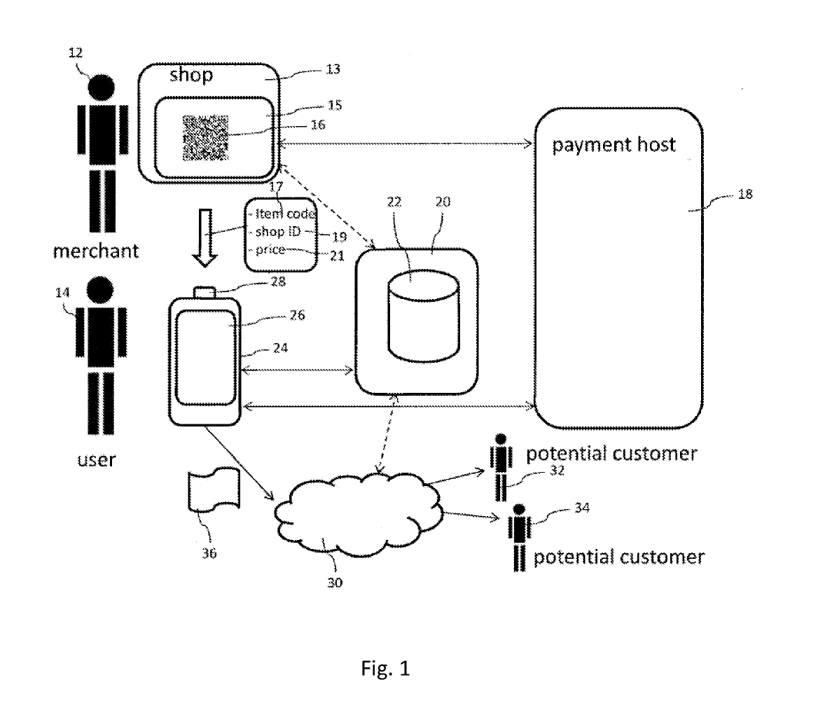

The mobile advertising system 10 is schematically illustrated in FIG. 1. Here, a merchant 12 operates a shop 13 to offer various products or services to a customer 14. The shop 13 may be operated online or offline and may be designed as a conventional retail store. The user 14 acting as a customer may select a single or several products or services to be purchased from the merchant's 12 shop 13. In order to process a payment, merchant 12 and user 14 may use a payment service provided by a payment host 18. The user 14 making use of a mobile device 24 may conduct a kind of online-payment to the merchant 12 by the services provided by the remote payment host 18.

The advertising system 10 provides an advertising functionality operable by a mobile device preferably interacting with a remote advertisement service. The advertising is based on encoded vending details 16 that are somehow provided or displayed in the shop 13 of the merchant 12. The encoded vending details are typically provided in a visual form (e.g. as a one-dimensional barcode or in form of a two-dimensional QR- or data-matrix code).

The encoded vending details 16 may either be static or dynamic and may reflect different vending related information, such as a unique code 17 of an item, of a product or of service, or a unique identifier 19 of the shop 13 and/or price information 21 regarding the product or service available at said shop 13. The mobile device 24 is operable to capture (e.g. to scan) the encoded vending details 16 and to decode the vending details 16 and to display such vending details via a display 26 to the user 14. Additionally or alternatively, the mobile device 24 is operable to generate a recommendation 36 on the basis of the captured and/or decoded vending details 16 and to transfer the recommendation 36 to at least one potential customer 32, 34 via a network 30.

In one embodiment, the encoded vending details 16 are indicative of the location and/or contact information of the shop 13. By decoding the captured vending details 16, the mobile device 24 may be operable to generate and to provide a recommendation 36 in a stand-alone mode. Typically, the user 14 may modify the recommendation 36 by adding a comment or other information to the captured vending details. For instance, the user 14 may post to the potential customers 32, 34 that shopping at the shop 13 is recommendable.

In another configuration the mobile device 24 of the user 14 is operable to communicate with an advertisement service 20 operating a database 22. The advertisement service 20 is operable to provide additional information to the user 14 upon request or automatically (e.g. in response to the mobile device 24 submitting the encoded or decoded captured vending details 16 to the advertisement service 20). If for instance, the vending details 16 are indicative of a unique identifier of a product, such as an EAN or UPC code, the advertisement service 20 may autonomously retrieve and provide additional information regarding the respective identified product. For instance, the advertisement service 20 may retrieve and provide information about various suppliers together with respective location and/or price information.

Moreover, the encoded vending detail may be indicative of the shop 13 itself. By submitting the encoded and captured vending details 16 to the advertisement service 20, shop-specific and shop-related information previously stored in the database 22 can be provided to the user 14 and to his mobile device 24.

In preferred embodiments, both, the merchant 12 as well as the customer 14, are subscribers of the advertisement service 20. This way, the merchant 12 can be enabled to frequently and to individually modify additional information stored in the database 22 and being assigned to the encoded information 16 which may be provided to the user 14 as a kind of a label. Hence, the merchant 12 may individually set and modify additional advertisement-related information in the database 22, which can then be automatically provided to the mobile device 24 of the user 14 via the database 22.

It may be of further benefit, that the encoded vending details 16 are individually producible by the merchant 12 making use of a respective computer-implemented encoding routine. Hence, the encoded vending details 16 can be actively displayed to the user by making use of a display device 15. Here, the merchant 12 may also make use of a mobile device operable to generate and to display encoded vending details, allowing to generate and/or to provide the encoded vending details to a user 14 actively and/or dynamically. The merchant may even instantly generate encoded vending details by making use of the software application. In this way, the merchant may create an individual offer to a user, who after purchasing a product or service may recommend this personal offer to a predefined number of friends. By means of the advertising system the merchant may create a special offer exclusively valid to those potential customers receiving the recommendation 36.

The encoded vending details may also be provided statically and/or passively by the merchant 12. Here, the merchant 12 may provide also printed encoded vending details 16 to a user 14 in form of a pre-configured standard label. The encoded vending details may then merely act as a label assigned with additional information stored in the database 22 of the advertisement service 20 that is to be submitted to the user 14 for generating a recommendation.

Hence, the encoded vending details 16 provided by the merchant 12 may also be indicative of payment details, such as the account number of the merchant 12 in regard of a payment host 18. It is, for instance, conceivable that the encoded vending details 16 are indicative of a particular product, its price, and the payment details of the merchant 12. By bringing the mobile device 24 in close proximity to the display 15 of the merchant 12, the encoded vending details 16 can be captured and can be displayed on a display 26 of the user's 14 mobile device 24.

The mobile device 24 may decode the captured vending details and may display the same to the user 14. The user 14 may then choose to initiate and to process a payment procedure. Here, the user 14 may directly use his mobile device 24 to transmit a payment order to a remotely located payment host 18. Typically, upon receipt of a payment order submitted by the mobile device 24, the payment host 18 may check authentication of the user and/or of the merchant 12. Typically, user 14 and merchant 12 comprise an account with the payment host 18. By processing and executing a payment order, a respective amount will be transferred among the respective accounts of merchant 12 and customer 14.

Once the payment has been completed, a respective confirmation is submitted to the merchant 12 and to the mobile device 24 of the user 14. This confirmation may be used to trigger generation of a recommendation 36. Generation of the recommendation 36 is based on the captured encoded vending details 16 and may further be based on information provided by the advertisement service 20 and/or of its database 22.

The advertisement service 20 may not only operate a database 22 providing additional information to a large variety of different shops 13 and their respective products or services but may also retrieve additional information about particular products on request. For instance, the advertisement service 20 may be operable to retrieve a best price offer by making use of a price search engine, browsing the internet for an identified product.

Once the recommendation 36 is generated either by the advertisement service 20 and/or by the mobile device 24 it can be submitted and transferred to at least one further potential customer 32, 34 via a network 30. Preferably, the network 30 is implemented as a social network of the user 14. By posting the recommendation 36 to the social network 30, all followers and potential customers 32, 34 linked to the user 14 can be almost instantaneously informed about the shopping activity actually completed by the recommending user 14.

Posting of the prepared recommendation 36 to the social network 30 may be conducted by the mobile device 24 or via the advertisement service 20 as indicated by the dashed arrow in FIG. 1.

The recommendation 36 is further indicative of its generating user 14 and the advertisement service 20. The recommendation 36 typically comprises a hyperlink to be followed or clicked by the potential customers 32, 34. Following of a recommendation 36, by clicking the hyperlink provided therein, is typically tracked by the advertisement service 20. If a potential customer 32, 34 actually follows a recommendation 36, a respective commission can be determined and provided to the advertisement service 20 and to the user 14 that generated or initiated generation of the recommendation 36. Hence, the user 14 may either receive a revenue or may receive a certain discount when repeatedly purchasing products or services from the merchant 12 or shop 13.

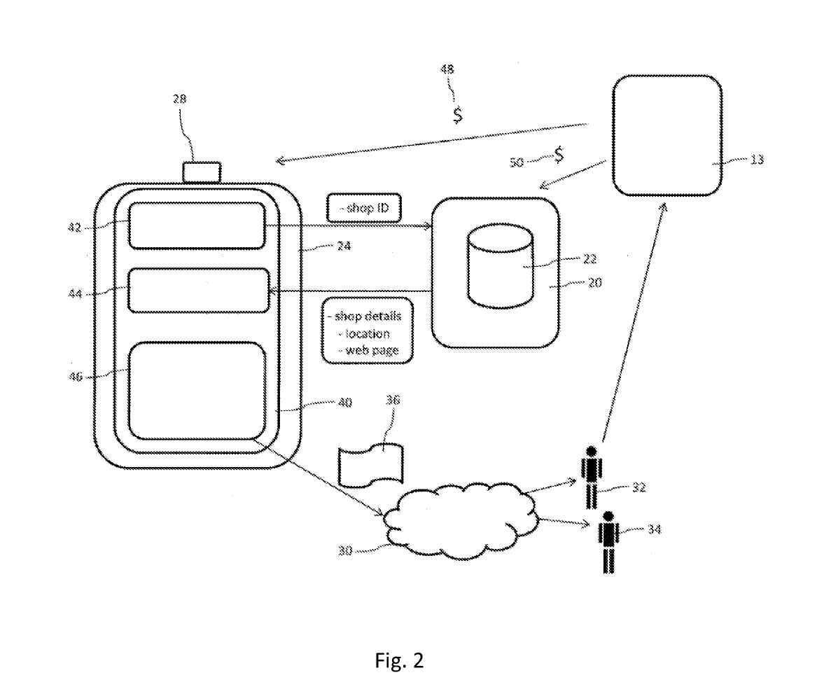

FIG. 2 schematically illustrates the mobile device 24 of the user 14 on which a respective computer program product is installed, preferably as a mobile software application 40. Here, the various modules of the software application 40 are schematically illustrated. The software application 40 is operable to process the encoded vending details 16 to be captured by a camera 28 of the mobile device 24. The software application 40 may be operable to decode the encoded vending details 16 and to display the same via a display 26 to the user 14. In order to create a recommendation 36 the software application 40 comprises a request module 42 by way of which the captured vending details 16 can be at least partially transferred to the advertisement service 20.

In response to such a request, the advertisement service provides additional information regarding the particular shop 13 and/or regarding a particular product or service available at said shop 13. This additional information is then returned to the mobile device 24 and is processed by a link generator 44. The encoded vending details 16 may, for instance only be indicative of a unique shop identifier 19. By way of submitting said shop identifier 19 to the advertisement service 20 additional information stored in the database 22 and assigned to the shop identifier 19 can be retrieved and returned to the mobile device 24 on request.

Such additional information may for instance reflect a physical location of the shop, its opening hours as well as other shop- or product-related information, such as a web-address of the respective shop 13 and special offers. In returning the additional information to the mobile device 24 the link generator 44 is typically operable to prepare a hyperlink to be embedded into the recommendation 36. Additionally, the software application 40 may provide a message module 46, in the form of a text editor, by way of which the user 14 may individually add a comment to the automatically generated recommendation 36.

The software application 40 may generate and prepare the recommendation and may prompt the user 14 to distribute the recommendation 36 among the social network 30. In doing so, the friends or followers 32, 34 of the user 14 will be automatically notified about the shopping recommendation 36 and will be encouraged to follow the recommendation. Since the recommendation 36 typically comprises a hyperlink it can be easily tracked when a follower or potential customer 32, 34 follows said hyperlink.

When the potential customer 32 follows the recommendation 36 he will be automatically forwarded to a web page or a shop of the merchant 12. By tracking such a following action, the advertisement service 20 and/or the user may receive a commission 48, 50. Here, the commission 48, 50 may strongly depend on the shopping behavior of the potential customer 32. If the potential customer 32 actually purchases products or services from the merchant 12, the commission 48, 50 to the user 14 and/or to the advertisement service 20 will be larger compared to situations where the potential customer 32 only visits a homepage of the merchant 12. By means of the advertisement service and the related software application 40 an affiliate marketing concept can be established, wherein the costs for operating the advertisement service 20 can be at least partially compensated by commissions provided by the merchant 12.

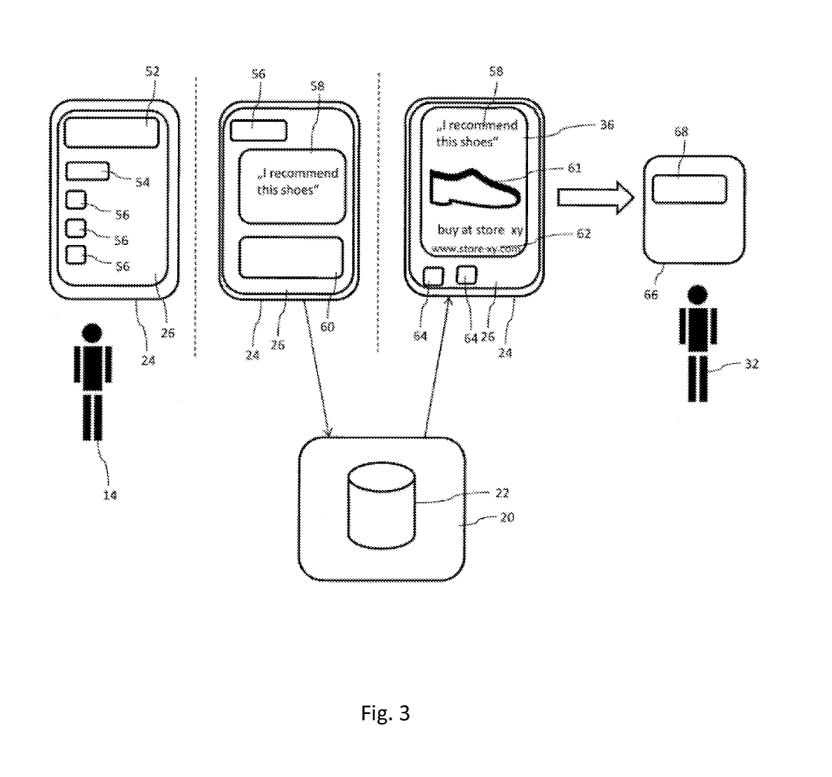

In FIG. 3 a sequence of operating steps of the mobile device 24 of the user 14 is illustrated. A first step as illustrated on the left of FIG. 3 starts with the completion of a payment process. In this situation, the mobile device 24 may indicate to the user 14 by means of a payment confirmation 52 that the payment has been successfully executed.

The mobile device 24 may then show various selecting items 54, 56 on its display 26. For instance, a shop item 54 or various product item 56 may be provided by way of which the user 14 may individually select whether he wants to recommend the shop 13 or various products or services recently purchased.

In a next step, the user 14 selects a particular product item 56 to create a recommendation 36. For instance, the product item 56 may be indicative of a product, like a pair of shoes. Upon activating the item selector 56 a text editor window 58 together with in input field 60 shows up thus enabling the user 14 to add a user-specific comment regarding the selected item. For instance, the user 14 may post a message such as “I recommend these shoes”. Additionally, the mobile device 24 submits a request to the advertisement service 20, which by processing of the respective request returns additional information regarding the selected product.

Supplementing a personal comment to the recommendation 36 may also be provided during and/or after receiving the additional product-, service- or shop-related information from the advertisement service 20. Hence, the request to the advertisement service 20 can also be submitted and processed prior to providing a text editor window 58 for making a user-specific comment. Therefore, preparing of a personal comment by making use of a text editor 58 may be conducted prior to, during, or after communication of the mobile device 24 with the advertisement provider.

On the basis of the previously captured encoded vending details 16 the advertisement service 20 identifies the respective product and provides additional information regarding the particular product. For instance, the advertisement service 20 may return a picture 61 of the respective shoe together with supplier information as additional information 62. In the present example the additional information 62 may be indicative of the shop 13 and may provide a hyperlink to the shop's homepage. The recommendation generated by the mobile device 24 then constitutes of the individual comment of the user 14 and the additional information returned from the advertisement service 20.

The software application 40 then additionally provides various share buttons 64, by way of which the user 14 may select a particular social network 30 to which the recommendation 36 should be posted.

Upon activating one or several of the share buttons 64, respective information of the recent trade activity of the user 14 will be posted to his social network 30, thereby, notifying those users 32, 34 of the social network 30 that are linked to the recommended user 14. Typically, the linked users 32, 34, which represent potential customers, utilize an electronic device 66, such as a personal computer, a mobile device, such as a smart phone, a portable computer or a tablet computer and will be accordingly notified about the electronic recommendation 36.

Consequently, a respective recommendation link 68 will show up on the electronic device 66 of the potential customers 32, 34. The recommendation 36 and/or the hyperlink typically embedded therein is also indicative of the user 14 that created the recommendation 36. This enables tracking of the potential customer 32 following the recommendation 36 and assigning the potential costumer activity to the user 14 for generating a commission for the advertisement service 20 and/or for the user 14.

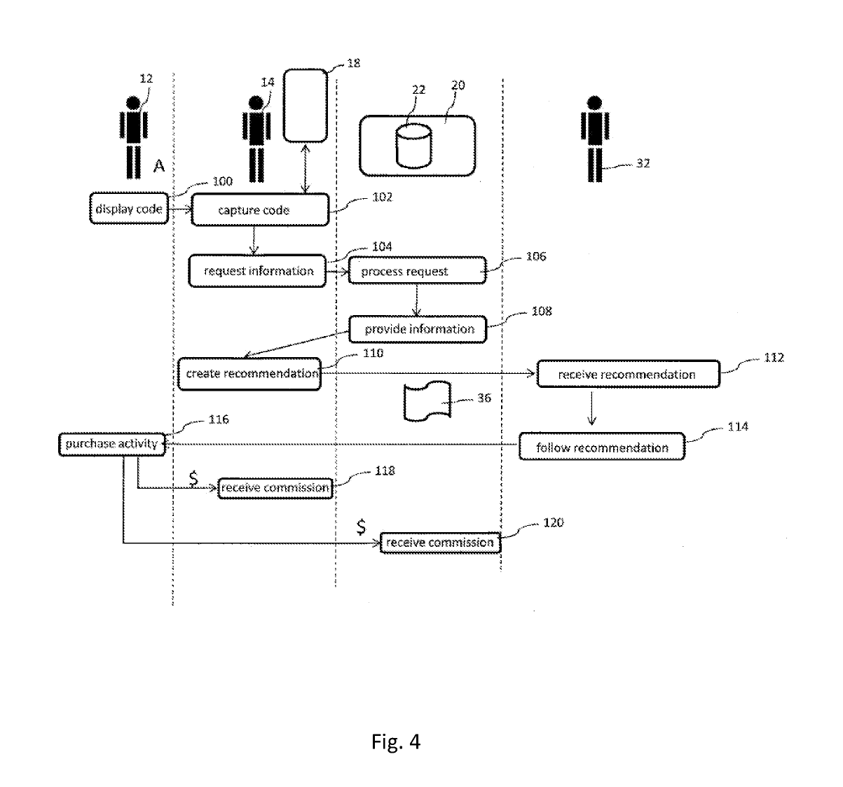

In FIG. 4 a flowchart of various process steps starting from purchasing an article until recommending the purchase is schematically shown. Here, in an initial step 100, the merchant either actively or passively displays encoded vending details 16 to a user 14. The user 14 in step 102 then captures the visually illustrated encoded vending details 16 by making use of his mobile device 24 and its camera 28. Since the encoded vending details 16 may also be indicative of price information and payment details, the captured code, which may be individually and dynamically generated and provided by the merchant 12, may be used by the user 14 to execute a payment via a remotely located payment host 18.

After completion of the payment procedure a recommendation function is offered to the user 14. The captured code 16 uniquely identifies at least the shop 13 of the merchant 12 and/or various products or services just purchased by the user 14. For generating a recommendation 36 the captured vending details 16 are at least partially transmitted to the advertisement service 20 in step 104 as a request either in encoded or decoded form.

In step 106 the advertisement service 20, also acting as an advertisement provider receives a respective request 106 and retrieves additional information regarding the captured vending details 16. For instance, the advertisement service 20 may retrieve additional information about the shop 13 and/or about the respective product or service that was actually purchased by the user 14. The retrieved additional information is returned to the user 14 in step 108. In a following step 110, the user 14 may provide additional user-specific information, which is to be embedded in the recommendation 36. The recommendation is actually generated by the mobile device 24 in step 110.

Subsequently, in step 112 the prepared recommendation is distributed among a social network 30 of the user 14 and is thereby provided to at least one potential customer 32. The potential customer 32 may then choose to follow the recommendation 36 by activating a hyperlink embedded in the received recommendation 36. By clicking on the hyperlink in step 114 and/or by purchasing similar products or services from the recommended merchant 12 in step 116 respective commissions will be provided to the user 14 in step 118 and to the advertisement service in step 120.

While at least one exemplary embodiment has been presented in the foregoing summary and detailed description, it should be appreciated that a vast number of variations may exist. It should also be appreciated that the exemplary embodiments are only examples, and are not intended to limit the scope, applicability, or configuration of the invention in any way. Rather, the foregoing summary and detailed description will provide those skilled in the art with a convenient instruction for implementing of at least one exemplary embodiment. It is to be understood, that various changes may be made in the function and arrangement of elements described in an exemplary embodiment without departing from the scope as set forth in the appended claims and their legal equivalence.

What is claimed is:

1. A mobile advertising system, comprising:
at least one mobile device configured to capture a merchant's encoded vending details, and being configured to communicate with a remote payment host; and
wherein upon completion of a payment procedure, the at least one mobile device is operable to generate a recommendation on the basis of the captured vending details and to transfer the recommendation to at least one potential customer via a network.

2. The mobile advertising system according to claim 1, further comprising an advertisement service to communicate with the at least one mobile device and comprising a database to provide additional information in response to receive the captured vending details.

3. The mobile advertising system according to claim 2, wherein the advertisement service is operable to generate the recommendation and to submit the recommendation to the at least one mobile device.

4. The mobile advertising system according to claim 2, wherein the advertisement service is operable to track the recommendation and to record if the at least one potential customer follows the recommendation.

5. The mobile advertising system according to claim 4, wherein the payment system is operable to determine and to provide a commission to the advertisement service and/or to the user of the at least one mobile device, when the potential user follows the recommendation.

6. The mobile advertising system according to claim 2, wherein the advertisement service and/or the mobile device is operable to submit the recommendation to a social network of the user of the mobile device.

7. The mobile advertising system according to claim 2, wherein the additional information stored in the database of the advertisement service is modifiable by the merchant.

8. The mobile advertising system according to claim 1, wherein the recommendation is modifiable by the user of the at least one mobile device.

9. A computer readable medium having computer readable instructions stored thereon for execution by a processor to perform a method of advertising, comprising the steps of:
capturing of a merchant's encoded vending details by means of a mobile device;
processing a payment with a remote payment host;
generating a recommendation upon completion of the payment procedure on the basis of the captured vending details; and
transferring the recommendation to at least one potential customer via a network.

10. A method according to claim 9, further comprising the steps of:
tracking the recommendation; and
determining and providing a commission to the user of the mobile device and/or to an advertisement provider when the potential customer follows the recommendation.

11. A computer program product to run on a mobile device of a user, comprising:
computer program means to capture a merchant's encoded vending details;
computer program means to process a payment with a remote payment host;
computer program means to generate a recommendation on the basis of the captured vending details after completion of the payment; and
computer program means to transfer the recommendation to at least one potential customer via a network.
